(19) United States
(12) Patent Application Publication
(10) Pub. No.: US 2007/0296133 A1
(43) Pub. Date: Dec. 27, 2007

(54) Modified Boiler Wall Tube Tool Having Inhibiting Means

(76) Inventor: Mark W. McClure, (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/425,537

(22) Filed: Jun. 21, 2006

(51) Int. Cl. B25B 1/10

(52) U.S. Cl. 269/241

(57) ABSTRACT

A boiler wall tube tool is disclosed and comprises a pair of opposed clamp members, means for securing the members to a boiler wall, and means for inhibiting ejection of the members from the boiler wall. Each one of the members comprises an aperture formed centrally therethrough for receiving securing means that is inserted through each of the apertures. Securing means may comprise a threaded bolt and a threaded nut, wherein the nut may be fixed or floating. Inhibiting means may comprise a pin having a stop formed at an end thereof, or a bolt having a threaded end formed at an end thereof. In the bolt type inhibiting means, the threaded end is threadably coupled to a nut, wherein the nut may be fixed or floating.

### RELATED U.S. APPLICATION DATA

Not applicable.

### BACKGROUND OF THE INVENTION

1. Field of the Invention

This invention relates generally to a tool for use in securing the ends of a boiler tubes along a boiler wall in aligned relation so that the ends of the tubes may be joined via welding. Specifically, this invention relates to a modified boiler wall tube tool in which boiler tubes in the form of a wall can be clampingly secured to retain adjacent ends of the boiler tubes forming the wall in aligned relation when connection the ends of the boiler wall tubes by welding and having means for inhibiting ejection or propulsion of one or both of the clamp members should means for securing the clamps to the boiler tubes fail.

2. Description of the Related Art

Tools for clamping and aligning boiler tubes when connecting the ends of the boiler tubes by welding are known as disclosed in U.S. Pat. Nos. 4,493,139, 4,579,272 and 4,722,468. The devices disclosed in the above-mentioned patents include structures for securing boiler tube ends in aligned and adjacent relation and function effectively when the boiler tubes are in spaced relation. However, in boiler wall tubes, the boiler tubes are positioned in closely spaced relation and are interconnected by webs to form a continuous boiler tube sheet or wall. The tools disclosed in the above-mentioned patents are not especially adapted for use with boiler tubes forming a boiler wall.

In addition, and considered relevant to the present invention, are U.S. Pat. Nos. 4,846,391 and 4,936,500, both issued to Gary McClure, disclosing various embodiments of boiler wall tube tools that clampingly engage the respective tubes to facilitate welding in the repair of a wall tube or tubes. The '391 patent discloses a boiler wall tube tool having a pair of opposed clamp members that includes a pair of recesses to engage adjacent ends of a pair of boiler wall tubes on opposite sides of a juncture between adjacent ends. The tool includes means for moving the clamps toward one another, thereby generating a secure clamp engagement between the clamps onto the respective tube or tubes. Moving means is described as a handle and a mounting bar that is inserted through each of the clamps. The '500 patent is a variation of the '391 patent is some respects, and specifically discloses a boiler wall tube tool that is bolted directly onto the boiler tube wall as opposed to utilizing a handle and mounting bar combination disclosed in '391. However, neither of the Gary McClure patents demonstrate an ability to provide versatility to the user in accommodating varying sizes beyond the dimensions of the recesses provided in the '391 and '500 disclosures, and to provide a safety feature of having an additional means for preventing the violent ejection or propulsion of one or both of the members if the securing means fails. The present invention overcomes this deficiency by providing the user with the ability to use the present invention on variously sized/dimensioned tubes and providing an additional element of safety in the form of inhibiting means that prevents one or both of the members from being violently ejected if the securing means fails.

Other prior art considered relevant to the present invention includes U.S. Pat. No. 5,481,793 (also issued to Gary McClure), U.S. Pat. No. 2,612,821 (issued to Skay), U.S. Pat. No. 6,007,029 (issued to Barringer et al.), U.S. Pat. No. 5,083,372 (issued to Polutnik), U.S. Pat. No. 5,044,075 (issued to Brennan et al.), U.S. Pat. No. 4,979,294 (issued to Bowman et al.), U.S. Pat. No. 6,308,921 (issued to Borzucki), and the group of U.S. Pat. Nos. 5,893,209, 5,974,642, 6,182,354 and 6,385,841 (all issued to Weeks).

### SUMMARY OF THE INVENTION

In one aspect of the present invention, a boiler wall tube tool is disclosed and comprises a pair of opposed clamp members, means for securing the members to a boiler wall, and means for inhibiting ejection of the members from the boiler wall. Each one of the members comprises an aperture formed centrally therethrough for receiving securing means that is inserted through each of the apertures. Securing means may comprise a threaded bolt and a threaded nut, wherein the nut may be fixed or floating. Inhibiting means may comprise a pin having a stop formed at an end thereof, or a bolt having a threaded end formed at an end thereof. In the bolt type inhibiting means, the threaded end is threadably coupled to a nut, wherein the nut may be fixed or floating. Alternatively, the threaded end may be threadably coupled to internal threads formed in at least one of the members.

The members may comprise a variety of configurations. In one aspect of the members, at least one of the members comprises a pair of recesses engaging a pair of boiler wall tubes. And, at least one of the members comprises a pair of recesses formed in the sides of the member providing access to the periphery of the boiler wall tubes. In another aspect of the members, at least one of the members comprises at least one recess to engage adjacent ends of a boiler wall tube on opposite sides of a juncture between the adjacent ends. In another aspect of the members, at least one of the members comprises a front and a rear, with a first pair of recesses formed at the front and a second pair of recesses formed at the rear, and with one pair of the recesses engaging a pair of boiler wall tubes. And, at least one of the members has a pair of recesses formed in the sides of the at least one clamp member providing access to the periphery of the boiler wall tubes. In another aspect of the members, at least one of the members comprises a nose intermediately disposed between a recess and a planar wall, and an aperture formed centrally through the at least one member. In another aspect of the members, at least one of the members comprises a nose intermediately disposed between a recess and an inclined wall, and an aperture formed centrally through the clamp member. In another aspect of the members, at least one of the members comprises a first radius opposite to a second radius, the radiuses having different dimensions.

As discussed above, the method and/or device of the present invention overcomes the disadvantages inherent in the prior art methods and devices. In this respect, before explaining at least one embodiment of the present invention in detail, it is to be understood that the invention is not limited in it s application to the details of construction and to the arrangement of the components or elements set forth in the following description or as illustrated in the drawings. The inventions is capable of other embodiments and of being practiced and carried out in various ways. Also, it is to be understood that the phraseology and terminology employed herein are for the purpose of description and should not be regarded as limiting the scope of the invention.

Accordingly, those skilled in the art will appreciate that the conception upon which this invention is based may readily be utilized as a basis for the design of other structures, methods, and systems for carrying out the purpose or purposes of the present invention. Therefore, it is important that the claims be regarded as including such equivalent constructions insofar as they do not depart from the spirit of the present invention.

Furthermore, the purpose of the foregoing “Abstract” is to enable the U.S. Patent and Trademark Office and the public, generally, and especially including the practitioners in the art who are not familiar with patent or legal terms or phraseology, to determine quickly from a cursory inspection, the nature and essence of the technical disclosure of the application. The “Abstract” is neither intended to define the invention of the application, nor is it intended to be limiting to the scope of the invention in any way. It is intended that the application is defined by the claims appended to this application.

### BRIEF DESCRIPTION OF THE DRAWINGS

Additional utility and features of the invention will become more fully apparent to those skilled in the art by reference to the following drawings, which illustrate the primary features of the preferred embodiment and numerous alternative embodiments.

FIG. 1 is a perspective view of a boiler wall tube tool coupled to a boiler wall, the tool having means for securing the tool to the boiler wall and further having at least one type of means for inhibiting the ejection or propulsion of one of the members from the wall;

FIG. 2 is a sectional view of FIG. 1 taken along line III-III and depicting one of the means for inhibiting ejection of one of the members, wherein the means comprises a pin with a stop or catch;

FIG. 3 is a sectional view of FIG. 1 taken along line III-III and depicting one of the means for inhibiting ejection or propulsion of one of the members, wherein the means comprises a bolt;

FIG. 4 is a sectional view of FIG. 1 taken along line IV-IV and depicting means for securing the members together about a boiler wall tube;

FIG. 5 is a perspective view of another embodiment of at least one of the members of the present invention;

FIG. 6 is a top or bottom view of one embodiment of at least one of the members of the present invention, specifically depicting a substantially E-shaped member comprising a pair of recesses;

FIG. 7 is a top or bottom view of another embodiment of at least one of the members of the present invention, specifically a member having a single recess;

FIG. 8 is a top or bottom view of another embodiment of at least one of the members of the present invention, specifically a member having a single recess and an alternate embodiment of FIG. 7;

FIG. 9 is a top or bottom view of another embodiment of at least one of the members of the present invention, specifically a member having a plurality of recesses on each side (a front and a rear), the recesses on the front having a different dimension than the recesses on the rear, and thus, the member is reversible to accommodate differently sized boiler wall tubes;

FIG. 10 and FIG. 11 are each a top or bottom view of another embodiment of at least one of the members of the present invention, specifically a member having a single recess, a wall and a nose intermediately disposed therebetween, and more specifically members having substantially the same configuration as described but with one of the members reversed so that the wall of one member is aligned with the recess of the other member, and vice versa, with FIG. 11 depicting a wall having an angle α inclined from normal;

FIG. 12 is a top or bottom view of another embodiment of at least one member of the present invention, wherein the member comprises an elongated body having an egg-shaped cross-section, the member having a radius at one end, a radius at an opposing end and a length or distance intermediately disposed therebeween, the radiuses of different dimensions so that the member is reversible to accommodate variously sized boiler wall tubes; and

FIG. 13 is a top or bottom view of another embodiment of at least one member of the present invention, wherein the member comprises a cylindrical body that is combined with another body (also depicted as cylindrical) having a continuous and uniform radius.

### DETAILED DESCRIPTION OF THE PREFERRED EMBODIMENT

The detailed description set forth below is for preferred embodiments and is intended to explain the present invention. It is to be understood that a variety of other arrangements are also possible without departing from the spirit and scope of the present invention.

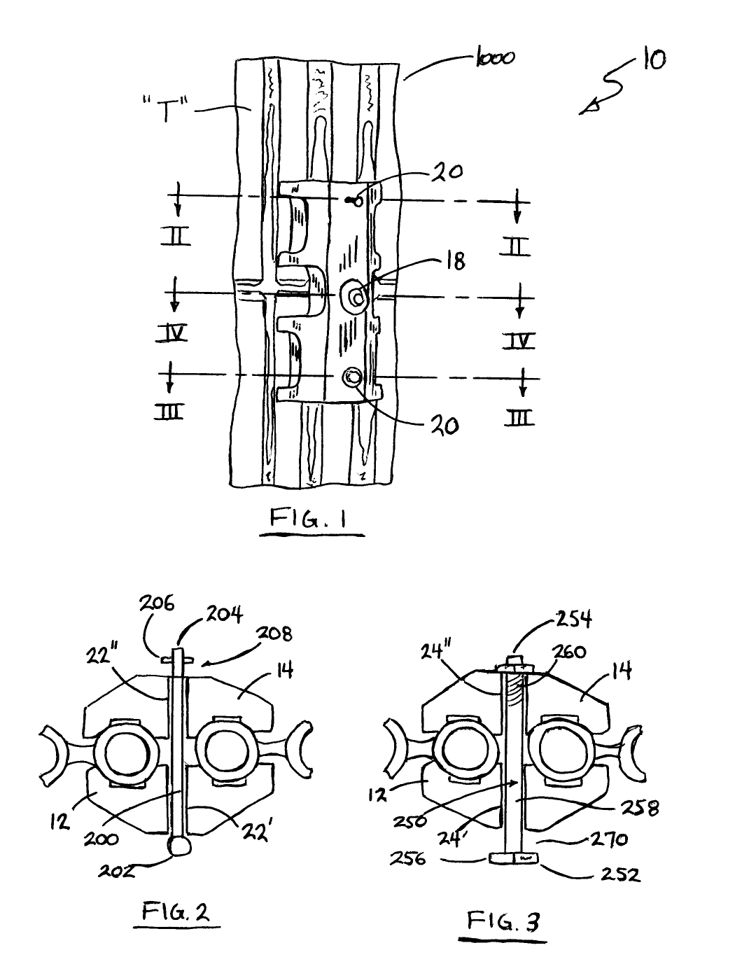

Referring now to FIG. 1 through FIG. 13, a boiler wall tube tool 10 (hereinafter “tool”) is depicted in accordance with at least one embodiment of the present invention, wherein the tool 10 comprises a pair of opposed clamp members 12 and 14, wherein each one of the members 12 and 14 comprise an aperture 16′ and 16″, respectively, formed centrally through the members 12 and 14. The tool 10 further includes means 18 for securing the members 12 and 14 to a boiler wall 1000 through each of the apertures 16′ and 16″. The tool 10 further includes means 20 for inhibiting ejection of the members 12 and 14 from the boiler wall 1000.

The clamp members 12 and 14 will be described in greater detail below, especially with regard to the number and variety of configurations the members 12 and 14 that may be utilized and incorporated into the tool 10. It is envisioned that the members 12 and/or 14 disclosed below may be selected or arranged so that the members 12 and 14 are identical, or alternatively, in varied combinations selected from the configurations disclosed below.

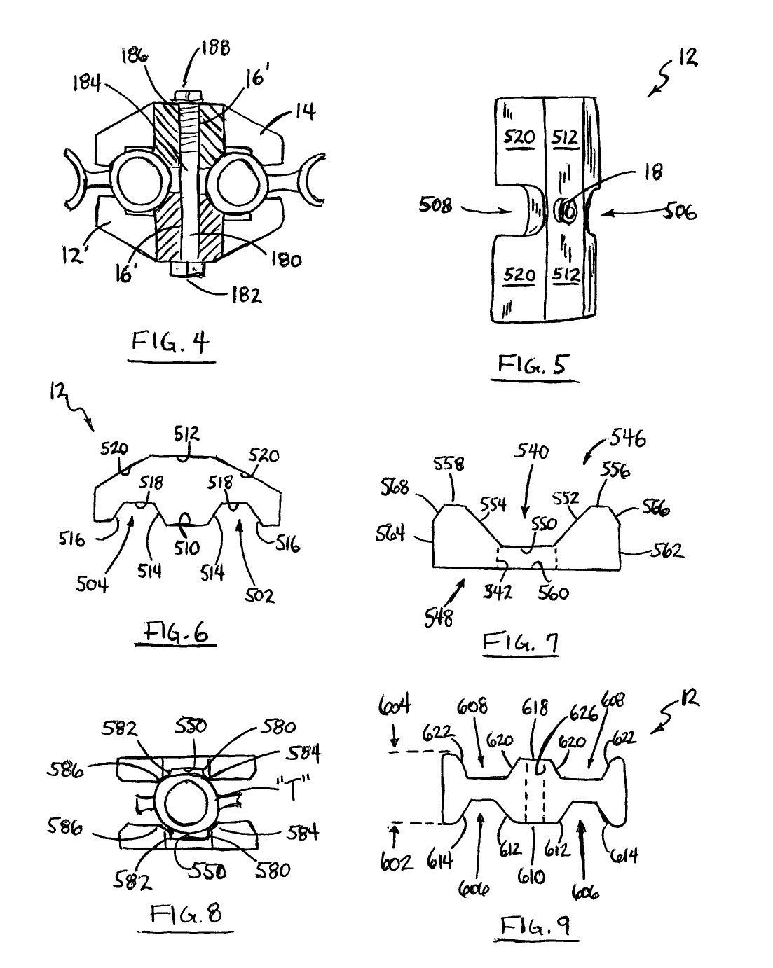

Means 18 for securing the members 12 and 14 to a boiler wall 1000 may include a variety of apparatuses and/or devices. It is envisioned, and as depicted in FIG. 4, one embodiment includes the use of a bolt 180 having a head 182, an elongated shaft or body 184, and a threaded portion 186 opposite to the head 182. Means 18 may further include internal threads formed along the aperture 16′ or 16″ of the respective members 12 and 14, or may further include a floating or a fixed threaded nut 188 that is threadably coupled to the threaded portion 186 of the bolt 180.

Means 20 for inhibiting ejection of the members 12 and/or 14 from the boiler wall 1000, after the members 12 and 14 are coupled to the boiler wall 1000, may include a variety of apparatuses and/or devices inserted through apertures 22′ and 22″ formed adjacent the top or the bottom of the respective members 12 and 14. Means 20 inhibits the member(s) 12 and/or 14 from laterally moving beyond a defined margin or perimeter in the event means 18 is inadvertently loosened, damaged, breaks or otherwise fails to adequately secure the members 12 and 14 to the boiler wall 1000. For instance, if means 18 fails under the stress exerted to maintain the members 12 and 14 onto boiler wall 1000, then either of the members 12 and/or 14 may travel away from the boiler wall 1000 in response to the sudden release of force experienced when means 18 fails. A repair worker may be injured as a result, with one of the members 12 or 14 propelled away from the boiler wall 1000 and into the body of the worker, which includes potential injury to the head generally and to the eyes, nose, mouth in particular. Thus, means 20 is envisioned as providing additional protection against such injury or trauma. It is further envisioned that means 20 may comprise an enlarged and sufficiently strong cotter pin or cotter key, as but one example of the suitable substitutes envisioned.

As depicted in FIG. 2, means 20 may include a pin 200 inserted through apertures 22′ and 22″ so that at least one of the ends 202 and 204 of the pin 200 form the outer margin or perimeter of permissible lateral movement of the members 12 and 14 in response to means 18 failure. For instance, the pin 200 may include a stop, a catch or other means 206 for inhibiting the pin 200 from re-entry into the aperture(s) 22′ or 22″, and thus, inhibiting the member(s) 12 and/or 14 from traveling beyond the margin or perimeter defined by the pin 200. The maximum distance of travel permitted by the pin 200 and the stop or catch 206 is defined by the space denoted by reference numeral 208.

It is also envisioned, and further depicted in FIG. 3, that means 20 may include a bolt 250 inserted into and/or through apertures 22′ and 22″ (similar to the pin 200, but not shown) or through apertures 24′ and 24″ so that at least one of the ends 252 or 254 of the bolt 250 form the outer margin or perimeter of permissible lateral movement of the members 12 and 14 in response to means 18 failure. For instance, the bolt 250 may have substantially the same or similar configuration of the bolt 180 described above, with a head 256, a body or shaft 258, and a threaded portion 260 opposite the head 256. The threaded portion 260 may threadably engage a threaded portion of the aperture(s) 22′ or 22″ so as to partially couple the members 12 and 14 about the bolt 250, but coupled in a manner that provides excess space 270 to allow the member 12 or 14 to travel a minimal distance if means 18 fails and one of the members 12 or 14 is propelled away from the boiler wall 1000. Specifically, the member 12 or 14 will travel within the space 270 and strike against the head 256 of bolt 250, with further travel or progress impeded by the head 256 of bolt 250.

It is further envisioned that means 20 may comprise a plurality of pins 200, a plurality of bolts 250, or a combination of a pin 200 and a bolt 250. The plurality of pins 200, plurality of bolts 250, or the combination thereof, may be inserted through the apertures 22′ and 22″ and additional apertures 24′ and 24″, respectively.

Each one of the members 12 and 14 may have a variety of configurations. In one such embodiment, at least one of the clamp members 12 or 14 (and by example only, the reference numeral 12 is used to denote the member described in FIG. 5 and FIG. 6) has a length (longitudinal) longer than the width (lateral). It is envisioned that each clamp member 12 and 14 may have the same or substantially identical configuration to the other member 12 or 14. Along the front or face of the clamp member 12, the recesses 502 and 504 are oriented parallel to the length of the clamp member 12 or 14, with the recesses 502 and 504 present along the length of the clamp member 12 or 14 except for the interruption due to the presence of the pair of recesses 506 and 508 formed in the side of the clamp member 12 or 14. As such, and at these positions, only a portion of the recesses 502 and 504 are present, that being the inner inclined surface of the recesses 502 and 504. A flat frontal surface 510 is formed and disposed intermediately to the respective inner inclined surfaces 514 of the recesses 502 and 504, the flat frontal surface 510 operating as a ridge or rib separating the respective recesses 502 and 504. The flat frontal surface 510 is parallel to a flat rear surface 512. The surfaces 510 and 512 are separated by the thickness of the clamp member 12 or 14. Each recess 502 and 504 comprises an inner inclined surface 514, an outer inclined surface 516 and a flat surface 518 intermediately disposed to surfaces 514 and 516.

Substantially opposite to the recesses 502 and 504 formed at the front of the clamp member 12 or 14, outer inclined surfaces 520 extend from the flat rear surface 512 to the margins of the clamp member 12 or 14. In cross section and looking from above or below, the clamp member 12 or 14 has an appearance similar to the shape of a modified version of the capital letter “E”. If the clamp member 12 or 14 is rotated, so that one is viewing the rear of the member 12 or 14, as the outer inclined surfaces 520 are oriented substantially similar to the recesses 502 and 504, the outer inclined surfaces 520 are also interrupted by the recesses 506 and 508 formed in the side of the clamp member 12 or 14.

In another embodiment of the present invention, depicted in FIG. 7, at least one of the clamp members 12 or 14 comprises a recess 540 for engaging a boiler wall tube “T”, and a recess 542 formed adjacent recess 540 for providing access to the boiler wall tube “T”. The clamp member 12 and/or 14 may be described as having a length (longitudinal) longer than the width (lateral). Along the front or face 546 of the clamp member 12 or 14, the recess 540 is oriented parallel to the length of the clamp member 12 or 14. The rear 548 of the clamp member 12 or 14 is relatively flat except for the interruption of the pair of recesses 542 and 544 formed in the sides of the clamp member 12 or 14.

Specifically, the clamp member 12 or 14 may be described as having a front 546 and a rear 548, wherein the recess 540 is formed in the front 546 of the clamp member 12 or 14. The recess 540 comprises a flat front surface 550 intermediately disposed between a pair of inclined surfaces 552 and 554, respectively, and with each terminating at a flat surface 556 and 558, respectively. The flat surface 550 is opposite of and parallel to a flat rear surface 560. The flat rear surface 560 terminates at opposing ends and forms a substantially orthogonal corner with an opposing pair of sidewall surfaces 562 and 564, respectively. Inclined surface 566 is intermediately disposed between the flat surface 556 and the sidewall surface 562, and the opposing inclined surface 568 is intermediately disposed between the flat surface 558 and the sidewall surface 564.

In another embodiment of the recess 540 as depicted in FIG. 8, the recess 540 may comprise a flat surface 550 intermediately disposed between walls 580 and 582 and forming a recess 540 having a substantially orthogonally form, so that the junction between surface 550 and wall 580 and the junction between surface 550 and wall 582 form approximate right angles. A pair of corners 584 and 586 are disposed distally from the flat surface 550, the corners 584 and 586 engaging the circumferential surface of the boiler tube “T”.

In another embodiment of the present invention, and as depicted in FIG. 9, at least one of the clamp members 12 or 14 comprises a reversible clamp member comprising recesses 600 on its front and rear. The clamp member 12 or 14 comprises a front 602 and a rear 604. A first pair of recesses 606 is formed at the front 602 and a second pair of recesses 608 is formed at the rear 604. The clamp member 12 or 14 is arranged and oriented so that one pair of the recesses 606 or 608 engage a pair of boiler wall tubes “T”, while the other opposing pair of the recesses 606 or 608 is oriented so as to face away from the boiler wall tubes “T”. The tool 10 also includes a pair of recesses (not shown) formed in the sides of the clamp member 12 or 14 providing access to the periphery of the boiler wall tubes “T”.

The recesses 606 are different in dimension from the recesses 608, so that recesses 606 accommodate a range of diameters for a boiler wall tube, and the recesses 608 accommodate a larger or smaller range of diameters for a boiler wall tube “T”. Thus, the clamp member 12 or 14 is reversible so as accommodate a variety of boiler wall tube diameters.

In greater detail, the recesses 606 are oriented parallel along the length of the clamp member 12 or 14 except for the interruption due to the presence of the pair of recesses (not shown) formed in the side of the clamp member 12 or 14. As such, and at these positions, only a portion of the recesses 606 are present, that being the inner inclined surface of the recesses 606. A flat frontal surface 610 is formed and disposed intermediately to the inner inclined surfaces 612 of the recesses 606, the flat frontal surface 610 operating as a ridge or rib separating the respective recesses 606. The flat frontal surface 610 is parallel to a flat rear surface 618, which is formed substantially similar to that of the flat frontal surface 610. The flat frontal surface 610 and the flat rear surface 618 differ only in length as determined by the respective dimensions of the recesses 606 along the front 602 and the recesses 608 along the rear 604. The surfaces 610 and 618 are separated by the thickness of the clamp member 12 or 14. Each recess 606 comprises an inner inclined surface 612, an outer inclined surface 614 and a flat surface 616 intermediately disposed to surfaces 612 and 614. Likewise, each recess 608 comprises an inner inclined surface 620, an outer inclined surface 622 and a flat surface 624 intermediately disposed to surfaces 620 and 622. As depicted in FIG. 9, the recesses 606 each have a smaller dimension than the recesses 608, and results in the length of flat frontal surface 610 being slightly longer than the flat rear surface 618. A recess 626 is provided through which securing means is inserted to secure the tool 10 to the tube wall.

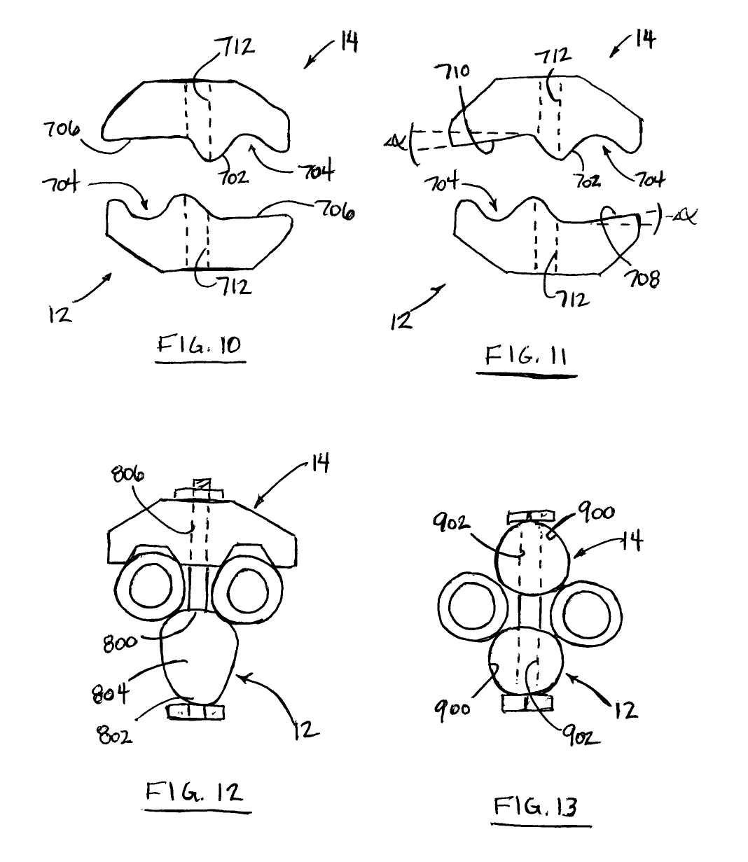

In another embodiment of the present invention, and as depicted in FIG. 10 and FIG. 11, the clamp member(s) 12 or 14 are substantially identical and comprises a nose 702 intermediately disposed between a recess 704 and a planar wall 706, in which the wall 706 is substantially transversely flat for contacting or engagement with the external surface of the tubes 1000. Alternatively, the wall 706 may also comprise an incline (as depicted in FIG. 11), which allows for keeping clamp members 12 and 14 in parallel plane in relation to each other in the water wall as larger or smaller diameters tubes in different spaces and sizes are encountered for centering purposes. The inclined wall 708 or 710 may be inclined at an angle ∠α of between greater than 0 degrees (0 degrees corresponding to a planar wall 706) and 12 degrees. A recess 712 is provided through which securing means is inserted to secure the tool 10 to the tube wall.

In another embodiment of the present invention, and as depicted in FIG. 12, the clamp member(s) 12 or 14 comprise a first radius 800 opposite to a second radius 802, the radiuses 800 and 802 having different dimensions. The radiuses 800 and 802 are arranged so that radius 800 has a larger dimension than radius 802. It is envisioned that the normal positioning of the clamp member 12 or 14 is such that the radius 800 engages the boiler wall tube and radius 802 is exposed. The clamp member 12 or 14 may be specifically described as having a radius 800, a radius 802 and a length, distance or width 804 intermediately disposed between the radiuses 800 and 802, respectively. This arrangement provides maximum exposure of the boiler wall tubes “T” Alternatively, it is also envisioned that the clamp member 12 or 14 is reversible so that radius 802 engages the boiler wall tube and the radius 800 is exposed, and thus, the larger radius 800 is exposed and minimizing the area of exposure of the boiler wall tubes “T”. However, such an arrangement may be necessary to accommodate boiler wall tubes “T” having a smaller diameter or for imperfections that may render using the larger radius 800 ineffective or impracticable. A recess 806 is provided through which securing means is inserted to secure the tool 10 to the tube wall.

In another embodiment of the present invention, and as depicted in FIG. 13, the clamp member(s) 12 or 14 comprise a radius 900 and having a recess 902 provided for insertion of securing means therethrough for securing the tool 10 to the tube wall.

What is claimed is:

1. A boiler wall tube tool comprising:
a pair of opposed clamp members;
means for securing the members to a boiler wall; and
means for inhibiting ejection of the members from the boiler wall.

2. The tool of claim 1, wherein each one of the members comprises an aperture formed centrally therethrough.

3. The tool of claim 2, wherein securing means is inserted through each of the apertures formed in the clamp members.

4. The tool of claim 3, wherein securing means comprises a threaded bolt and a threaded nut.

5. The tool of claim 4, wherein the nut is fixed.

6. The tool of claim 4, wherein the nut is floating

7. The tool of claim 1, wherein at least one of the members comprises a pair of recesses engaging a pair of boiler wall tubes.

8. The tool of claim 7, wherein at least one of the members comprises a pair of recesses formed in the sides of the member providing access to the periphery of the boiler wall tubes.

9. The tool of claim 1, wherein at least one of the members comprises at least one recess to engage adjacent ends of a boiler wall tube on opposite sides of a juncture between the adjacent ends.

10. The tool of claim 1, wherein at least one of the members comprises:
a front and a rear;
a first pair of recesses formed at the front and a second pair of recesses formed at the rear, one pair of the recesses engaging a pair of boiler wall tubes;
a pair of recesses formed in the sides of the at least one clamp member providing access to the periphery of the boiler wall tubes

11. The tool of claim 1, wherein at least one of the members comprises a nose intermediately disposed between a recess and a planar wall, and an aperture formed centrally through the at least one member.

12. The tool of claim 1, wherein at least one of the members comprises a nose intermediately disposed between a recess and an inclined wall, and an aperture formed centrally through the clamp member.

13. The tool of claim 1, wherein at least one of the members comprises a first radius opposite to a second radius, the radiuses having different dimensions.

14. The tool of claim 1, wherein inhibiting means comprises a pin having a stop formed at an end thereof.

15. The tool of claim 1, wherein inhibiting means comprises a bolt having a threaded end formed at an end thereof.

16. The tool of claim 15, wherein the threaded end is threadably coupled to a nut.

17. The tool of claim 16, wherein the nut is fixed.

18. The tool of claim 16, wherein the nut is floating.

19. The tool of claim 16, wherein the threaded end is threadably coupled to internal threads formed in at least one of the members.
